(19) United States
(12) Patent Application Publication
(10) Pub. No.: US 2007/0024470 A1
(43) Pub. Date: Feb. 1, 2007

(54) WIRELESS COMMUNICATION DEVICE CAPABLE OF INDICATING DIRECTIONS

(76) Inventors: Dai-Shui Ho, Taipei (TW); Bo Yang, Shanghai City (CN)

Correspondence Address: NORTH AMERICA INTELLECTUAL PROPERTY CORPORATION, P.O. BOX 506, MERRIFIELD, VA, 22116, US

(21) Appl. No.: 11/460,244

(22) Filed: Jul. 26, 2006

(30) Foreign Application Priority Data
Jul. 28, 2005 (TW) 094125666

(51) Int. Cl. G08G 1/123

(52) U.S. Cl. 340/995.28

(57) ABSTRACT

A wireless communication device includes a direction detector. When a user makes a request to the wireless communication device to detect a direction, the wireless communication device detects the direction and then indicates the direction by displaying the direction on a display. By incorporating the direction detector into the wireless communication device, the wireless communication device can help its user to find a direction easily.

### BACKGROUND OF THE INVENTION

1. Field of the Invention

The present invention provides a wireless communication device, and more particularly, a wireless communication device capable of indicating a direction.

2. Description of the Prior Art

A compass is widely used in navigation and GPS systems. Modern electronic compasses, made of solid state materials, are gradually replacing traditional magnetic needles or magnetic compasses due to their precision, stability, etc. Further electronic compasses have interfaces for coupling with other electronic components. Thus they are commonly integrated into various products.

A typical electronic compass is implemented with a magnetic field sensor. A common magnetic field sensor is a fluxgate sensor, which uses two rods made of magnetic materials, or windings induced by currents of opposite directions to generate a driving magnetic field according to Faraday's Law. The driving magnetic field generates magnetic induction through magnetization. The resolving power of a typical fluxgate sensor is 1 μOe capable of measuring a DC or AC magnetic field of up to 10 kHz. The fluxgate sensor is cheap and durable, but cannot be easily integrated, and has low sensitivity and precision. Another common magnetic field sensor is a Hall sensor, implemented by inducing current into a conductor which is exposed in an external magnetic filed to measure its Hall voltage so as to determine the polarity and concentration of conducting carriers. It is called the Hall effect, and used to measure a magnetic field with an intensity of 100˜1000 Oe, thus is adequate to measure high intensity magnetic fields. When a magnetic field exists, the Hall effect occurs in metal or semiconductor with a carrier current. A Hall sensor, such as a silicon-type Hall sensor, is used in gear detection, rotation position detection, and current detection. It has the advantages of having a small size, low price, and ease of use, but has the drawbacks such as low sensitivity and low precision, just like the fluxgate sensor.

Although there are many products having functions similar to a compass, they are usually not easy to use, and they often have low precision. For high end positioning systems, they are often too big to carry around thus are not popular in the marketplace.

### SUMMARY OF THE INVENTION

The present invention discloses a wireless communication device capable of indicating directions. The wireless communication device comprises a user interface for inputting input signals, a processor coupled to the user interface for processing the input signals, a direction detector coupled to the processor for detecting directions, a transceiver coupled to the processor for processing communication signals, an antenna coupled to the transceiver for transmitting and receiving radio signals, and memory coupled to the processor for storing data.

The present invention discloses a method for indicating direction with a wireless communication device comprising two anisotropic magneto-resistive sensors outputting differential voltages according to their resistances, generating a direction according to the differential voltages, and indicating the direction.

The present invention further discloses a method for operating a wireless communication device comprising displaying personal assistant options, choosing a direction detecting option from the personal assistant options, enabling the direction detecting option, and indicating a detected direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a chip installed inside a wireless communication device according to an embodiment of the present invention.

FIG. 2 is a block diagram of the wireless communication device in FIG. 1.

FIG. 3 is a circuit diagram of the wireless communication device in FIG. 1.

FIG. 4 is a flowchart of a method for detecting the direction with the wireless communication device in FIG. 1.

FIG. 5 is a flowchart illustrating the operation of the wireless communication device in FIG. 1.

### DETAILED DESCRIPTION

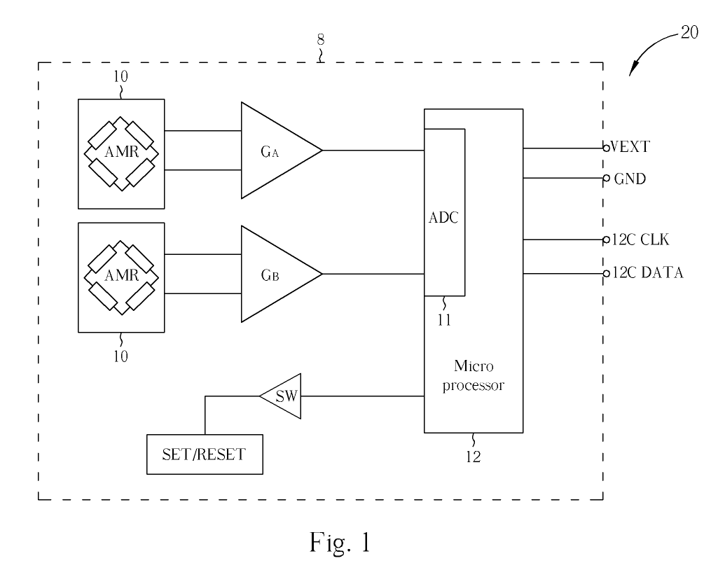

Please refer to FIG. 1. FIG. 1 is a chip 8 installed inside a wireless communication device 20 according to an embodiment of the present invention. The wireless communication device 20 can be a personal digital assistant, a cellular phone, a notebook, or other electronic portable devices. The wireless communication device 20 comprises two anisotropic magneto-resistive (AMR) sensors 10, which are two-axis magnetic sensors, installed on the chip 8. When the anisotropic magneto-resistive sensors 10 experience a magnetic field, the resistance of the anisotropic magneto-resistive sensors 10 changes with the magnetic field. The anisotropic magneto-resistive sensors 10 then output differential voltages accordingly. Since the experienced magnetic field is directly proportional to the magnitudes of the differential voltages, the differential voltages are converted into two-axis signals. The two-axis signals are amplified and then converted by an analog-to-digital converter 111 into digital signals. A microprocessor 12 on the chip 8 then calculates a tilt angle based on the digital signals.

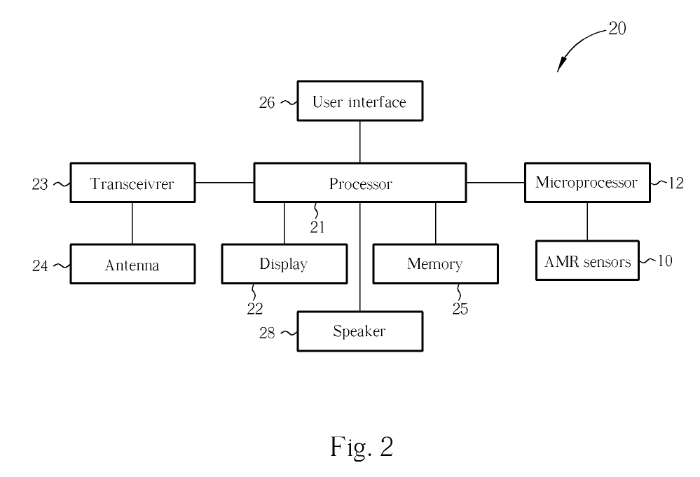

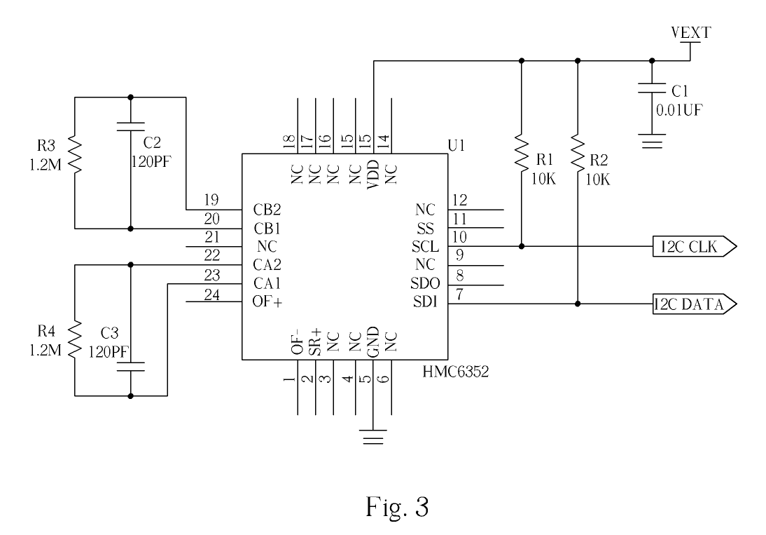

Please refer to FIGS. 2 and 3. FIG. 2 is a block diagram of the wireless communication device 20. FIG. 3 is a circuit diagram of the wireless communication device 20. The wireless communication device 20 further comprises a user interface 26 for inputting input signals, a processor 21 coupled to the user interface 26 and the microprocessor 12 for processing the input signals and processing the tilt angle calculated by the microprocessor 12 for generating a direction, a display 22 coupled to the processor 21 for displaying information such as the direction, a speaker 28 coupled to the processor 21 for outputting sound, a transceiver 23 coupled to the processor 21 for processing communication signals, an antenna 24 coupled to the transceiver 23 for transmitting and receiving radio signals, and memory 25 such as SRAM coupled to the processor 21 for storing data. When a user inputs a command to detect the direction through the user interface 26, the processor 21 controls the anisotropic magneto-resistive sensors 10 through the microprocessor 12 to detect the direction. Then the display 22 displays the detected direction.

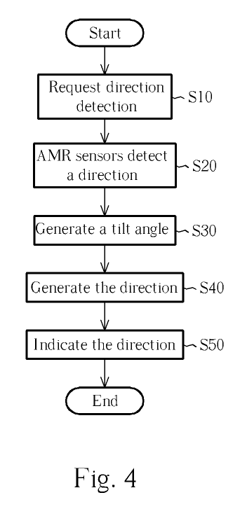

Please refer to FIG. 4. FIG. 4 is a flowchart of a method for detecting the direction with the wireless communication device 20. The method comprises the following steps:

Step S10: the user interface 26 requests direction detection;

Step S20: the anisotropic magneto-resistive sensors 10 output differential voltages according to their resistances, the differential voltages are converted into two-axis signals. The two-axis signals are amplified and then converted by the analog-to-digital converter 111 into digital signals;

Step S30: the microprocessor 12 on the chip 8 generates a tilt angle based on the digital signals;

Step S40: the processor 21 processes the tilt angle to generating a direction; and

Step S50: the display 22 displays the direction.

Step S50 can be performed by other means. For example, a speaker of the wireless communication device 20 can generate a voice signal to indicate the direction as well.

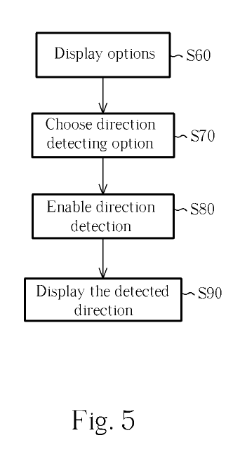

Please refer to FIG. 5. FIG. 5 is a flowchart illustrating the operation of the wireless communication device 20. The operation comprises the following steps:

Step S60: display personal assistant options such as the calendar option, dictionary option, game option, direction detecting option, etc.;

Step S70: choose the direction detecting option from the personal assistant options;

Step S80: enable the direction detecting option; and

Step S90: the display 22 displays the direction detected by the anisotropic magneto-resistive sensors 10.

The anisotropic magneto-resistive sensors 10 have high precision, high sensitivity and small size. Moreover, they do not need windings, and can be incorporated into a wireless communication device by an IC-like process. Thus by occupying very limited extra space inside the wireless communication device, the wireless communication device is capable of helping its user to find a direction.

Although the anisotropic magneto-resistive sensors 10 are used as a direction detector in this embodiment, the present invention is not limited to use the anisotropic magneto-resistive sensors 10 as the direction detector. Any wireless communications system with a sensor which is capable of detecting a direction is considered as a modification to the present invention and is included in the scope of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication device capable of indicating directions comprising:
a user interface for inputting input signals;
a processor coupled to the user interface for processing the input signals;
a direction detector coupled to the processor for detecting directions;
a transceiver coupled to the processor for transmitting and receiving communication signals;
an antenna coupled to the transceiver for transmitting and receiving radio signals; and
a memory coupled to the processor for storing data.

2. The wireless communication device of claim 1 wherein the direction detector comprises two anisotropic magneto-resistive sensors.

3. The wireless communication device of claim 1 wherein the direction detector is formed on a chip.

4. The wireless communication device of claim 1 wherein the memory is SRAM (Static Random Access Memory).

5. The wireless communication device of claim 1 further comprising a display coupled to the processor for displaying information.

6. A method for indicating direction with a wireless communication device comprising:
two anisotropic magneto-resistive sensors outputting differential voltages according to resistances thereof;
generating a direction according to the differential voltages; and
indicating the direction.

7. The method of claim 6 wherein generating the direction according to the differential voltages comprises:
converting the differential voltages into two-axis signals;
amplifying the two-axis signals;
converting the amplified two-axis signals into digital signals;
generating a tilt angle based on the digital signals;
processing the tilt angle for generating the direction.

8. The method of claim 6 wherein indicating the direction comprises displaying the direction on a display.

9. The method of claim 6 wherein indicating the direction comprises indicating the direction with a voice signal.

10. A method for operating a wireless communication device comprising:
displaying personal assistant options;
choosing a direction detecting option from the personal assistant options;
enabling the direction detecting option; and
indicating a detected direction.

11. The method of claim 10 wherein indicating the detected direction comprises displaying the detected direction on a display.

12. The method of claim 10 wherein indicating the detected direction comprises indicating the detected direction with a voice signal.
